(19) United States
(12) Patent Application Publication
(10) Pub. No.: US 2020/0202672 A1
(43) Pub. Date: Jun. 25, 2020

(54) Gifting Game

(71) Applicant: Stephanie Thirtyacre, Anthony, FL (US)

(72) Inventor: Stephanie Thirtyacre, Anthony, FL (US)

(21) Appl. No.: 16/725,765

(22) Filed: Dec. 23, 2019

Related U.S. Application Data
(60) Provisional application No. 62/783,277, filed on Dec. 21, 2018.

(51) Int. Cl. G07F 17/32; G06Q 20/10; G06Q 30/02

(52) U.S. Cl. CPC G07F 17/3267; G06Q 20/102; G06Q 30/0209; G06Q 30/0214; G07F 17/3227; G07F 17/3258; G07F 17/3295; G07F 17/3269; G07F 17/3276; G06Q 30/0215

(57) ABSTRACT

A method of playing a game having the steps of appointing an administrator, enrolling at a first set of players being least two players, providing said players a mechanism for electronic interaction with said administrator being a computer controlled device configured with an input-output and communications configuration with said administrator, collecting a fee from said players, commencing a game sequence by providing said players an initial game clue for solving a puzzle, providing a solution from any of said first set of players or said second set of players to the administrator, verifying said solution as being correct by said administrator and distributing a prize to the player submitting said verified solution.

### INDEX TO RELATED APPLICATIONS

This application is a non-provisional of and claims benefit to U.S. Provisional Patent Application Ser. No. 62/783,277 filed Dec. 21, 2018 the disclosure of which is incorporated herein by reference in its entirety.

### BACKGROUND OF THE INVENTION

There is no shortage of games that both entertain and educate. While many persons might perceive that there is nothing new in the gaming industry, those involved realize there is much untapped potential.

The present invention successfully addresses the potential.

### SUMMARY OF THE INVENTION

In one embodiment, the present invention provides a method for playing games whereby games are mixed with real life surrounding clues and not just computer-based knowledge.

In this embodiment, an answer could require players going to a park and finding an answer written on a statue. They could go to a public park that they believe the clues point to and find a plaque that has the answer for that clue. Go watch a movie that's currently playing in theaters and the answer is something in the movie.

In one embodiment, the present invention provides a method for playing games whereby a clue is not released until a certain level of money and/or joining players have been reached. This motivates players to encourage new players to come aboard through social media. Players can not advance their own game unless they promote it. They will be called Speed Share Buttons.

In one embodiment, the present invention provides a method for playing games whereby each player has the choice to give a gift after the puzzle is solved. A game coordinator will only hold the funds so actual gift is kept in the ownership of the player till after the winner is chosen.

This gives security to the player and the winner the confidence that a “treasure” does exist which is typically an issue in trusting a treasure is actually there to be found.

In one embodiment, the present invention provides a method for playing games whereby the game includes the step of using an email as the answer(i.e.:123456789@gmail.com) to the puzzle so the first answer is proven by the time stamp of the entry which gives integrity to winner. It can also be by a time stamp of going to a Youtube channel and commenting, or Facebook, Instagram, or calling a phone number and being the first caller. Go to a special website that they would input their answer. They could submit by US Mail which is postmarked.

In one embodiment, the present invention provides a method for playing games whereby the game involves the step of giving random prizes to registered players who are currently online which promotes the players staying on the site. Can be good prizes or booby prizes to increase entertainment value.

In one embodiment the present invention is a method of playing a game, said method comprising the steps of:
appointing an administrator;
enrolling at a first set of players being least two players;
providing said players a mechanism for electronic interaction with said administrator being a computer controlled device configured with an input-output and communications configuration with said administrator; collecting a fee from said players;
commencing a game sequence by providing said players an initial game clue for solving a puzzle;

optionally, enrolling a second set of players being additional players after said commencing;
providing a solution from any of said first set of players or said second set of players to the administrator;
verifying said solution as being correct by said administrator;
distributing a prize to the player submitting said verified solution.

In one embodiment, the method further comprises providing said administrator a computer-controlled device configured with an input-output and communications configuration to execute a program on a non-transitory computer readable medium to each of said enrolled players.

In one embodiment, the method further comprises requiring said first set of players recruiting and enrolling at least a second set of two players, each completed recruiting and enrolling being followed by transmitting to said first set of players at least one additional clue.

In one embodiment, the method further comprises requiring players enrolling additional players until a number of players reaches a threshold set by the administrator for releasing clues. In this embodiment, the administrator can lock an first set of players into a preferred position and give additional clues based on how many additional players are enrolled.

For example, player set 1 has three players Able, Baker and Charlie. The administrator has said twenty players are needed of a particular game. Able recruits twelve players, Baker recruits five players and Charlie recruits two players. The threshold is met and clues are released. Able will receive an initial clue set for the game and twelve additional clues as a reward for recruiting.

In one embodiment, the method further comprises a configuration whereby said distributing a prize to the player submitting said verified solution includes an ability to share or distribute the prize with at least one other player.

In one embodiment, the method further comprises said providing a solution includes comprising a time - date stamp with said solution for verification of an initial correct solution.

In one embodiment, the method further comprises players enrolling includes providing monetary enrollment fees.

In one embodiment, the method further comprises players enrolling includes providing monetary enrollment fees deposited into an escrow fund controlled by said administrator.

In one embodiment, the method further comprises players enrolling includes providing monetary enrollment fees deposited into an escrow fund controlled by a person or entity not in control of the administrator.

In one embodiment, the method further comprises distributing said prize to the player submitting said verified solution includes withdrawing money from monetary enrollment fees deposited into an escrow fund controlled by a person or entity not in control of the administrator.

### BRIEF DESCRIPTION OF THE SEVERAL VIEWS OF THE DRAWINGS

FIG. 1 is a flowchart of the steps according to one embodiment of the present invention.

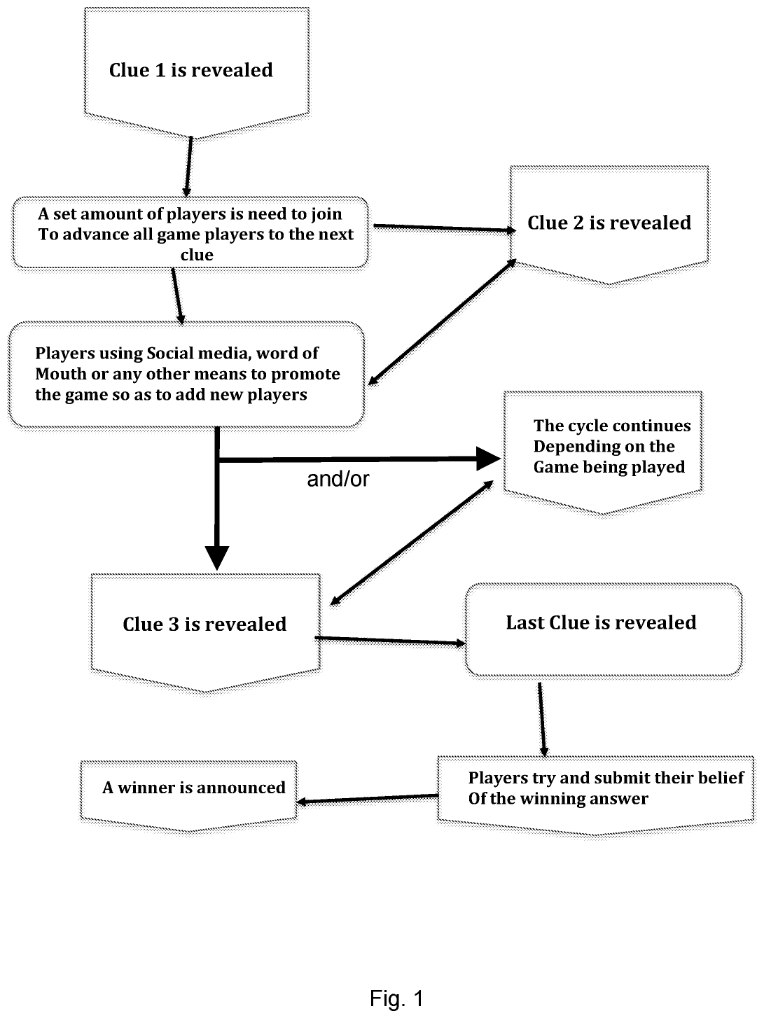

### DETAILED DESCRIPTION OF THE PREFERRED EMBODIMENT

As generally understood, the present invention provides a method for playing a novel game.

A game administrator provides access to participants. Access can be wireless by SMS/MMS, Internet based, or combinations thereof. Participants will have an appropriate devise for interaction by SMS/MMS, Internet based, or combinations thereof.

After providing access, the administrator initiates the game by providing a clue.

The game includes the step of setting a number of players for a particular game.

Revealing a second clue is followed by current players promoting additional players as instructed by the administrator.

Revealing additional clues as determined by the administrator occurs until the final step which would be a player submitting an answer. As understood, the game will end when either the step of submitting an answer is deemed to be the correct answer by the administrator, or the administrator ends the game for lack of a correct answer.

The game of the present invention is embodied in certain nonlimiting examples:

### Example 1

The entry fee of playing of skill is $5. A player will also be pledging an additional $5 to the entrant who submits the first answer to the Game. The Gift Vault tallies this total. The entry fee of $5 is nonrefundable. The additional $5 that is pledged to the entrant who submits the correct answer is refundable. The administrator holds that $5 in escrow for 90 days. Entrants have the ability to ask for a refund by writing within 30 days of the end of the session they entered. This time will be stated as the date and time of the winning solution email. If they don't ask for a refund within 30 days they are allowing that $5 to be considered a “gift” to the entrant who was declared the first one to answer the correct answer. Answers have to be exact and miss spellings or added letters or words will not be accepted as the correct solution even if they appear correct.

The first game that is played will consist of clues to answer the game/puzzle. Once the game reaches 1 million dollars in escrow, the email to send your answer to will be revealed shortly after. Therefore, whoever's email with the correct answer gets in with a time stamp will be declared to the Gift Receiver. The entrant who is declared to have given the winning solution will learn what their gift vault holds 90 days after the end of the session.

The object of the game, in this embodiment, is to build the gift vault with other players gift money that a player who solves the game/guzzle will get by way of being a gift from others. It's a crowdfunded gift giving game/puzzle.

### Example 2

A player comes to the website and pays $10. They read the initial clue that's posted on the site. Once a certain amount of people have played, the next clue will be revealed. This goes on for example 10 times. The last clue given requires an answer that is given to us to determine the winner. This answer could be given by an email that's been deciphered from the clues in order to have a time stamp. This version would require a prize that's determined prior to the game and comes directly from the company.

### Example 3

A player comes to the website and pays $10. $5 goes directly to the company, the other $5 goes into an escrow account that we call the “gift vault”. The game is played as above with clues and a winner submits the correct answer first. All the players have the ability to request their gift vault money back if they choose within a certain amount of time. After this time period, the winner finds out how much they were gifted which adds to entertainment value as well as keeps them coming back to the site to see the end tally.

### Example 4

In the embodiment including a treasure hunt component, The way the treasure hunt would work is that a player gives $10 to be able to play. $5 of that $10 goes to the administrator for purchase and/or administration of the puzzles. The other $5 goes to a “pot”(Escrow). In one embodiment, the player will get 10 (could change) puzzles over the course of the game. The pot grows as more people play. When the pot reaches $500 a second puzzle is released to all the players that have paid to play the game by their email address they submitted at the time of registration. It will also be released on the site just prior to the next puzzles release.

After the 10 puzzles have been released, one person will have figured out the answer of all 10 puzzles. The answer might look like this.

Puzzle #1 What's the name of the mouse at Disney World that wears a bow between her ears. The answer is Minnie . . . so the answer is M.

Puzzle #2 What color is the fruit that a monkey is known to eat. The answer is Banana . . . so the answer is B.

Puzzle #3 Where do the Cubs like to hit a ball. The answer is Wrigley Field . . . so the answer is W.

This goes on for 10 puzzles. Let's say the answer to all the puzzles is MBW4C9T5P2.

The first person to email MBW4C9T5P2@gmail.com (set up prior to the game) is the winner of the pot which is a gift from all the people who submitted to the pot.

To make this a legal gift, maybe they have the option at the end to decide if they want to gift to the winner or get their money back. They can only get $5 back as the $5 that went to us was a payment for the puzzles and administrative costs. This could make it exciting that within 48 hours they will watch to see what the actual gift is which can be engaging.

Also, to deter them from doing this, we can say that they aren't able to play anymore if they are a degifter.

The “treasure” would be tax free as each person is “gifting” by tax law $5.

So unless the gifter has already reached their limit, it should be tax free for all parties.

This can be a point for the patent to make it different than any other patent. The only treasure hunt where the winner receives the treasure from strangers. The only treasure hunt where players give to the winner directly.

The puzzle can increase over time. Puzzles can end up being a million dollars for example.

In other embodiment, the example of the Cubs—That clue could be answered by something that hasn't happened yet. For example the answer will be who wins the world series.

The Cubs or Sox and the answer would be a C.

The speed of the hunt is dependent on the speed of the purchasers to enter the game.

Puzzles/Clues don't get released until enough people can hit that next level to release it. This motivates people to generate more players themselves by promoting it to friends and family.

The actual puzzles can be very different than what's explained above as time goes on, but I want the patent aspect to be things like the speed of the game is dependent on players entering the game. The idea that each individual is directly giving to the solver which because of the small amount, is unlikely to be taxable to the gifter or the giftee.

The hunt can be online sometimes, it can be outside the home, it can be with the use of a geocache device so you have to be at that spot outside. It can include finding answers on the internet, or by decoding them.

The amount of the Gift Vault/Pot can be raised as time go on.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method of playing a game, said method comprising the steps of:
appointing an administrator;
enrolling at a first set of players being least two players;
providing said players a mechanism for electronic interaction with said administrator being a computer controlled device configured with an input-output and communications configuration with said administrator;
collecting a fee from said players;
commencing a game sequence by providing said players an initial game clue for solving a puzzle;
optionally, enrolling a second set of players being additional players after said commencing;
providing a solution from any of said first set of players or said second set of players to the administrator;
verifying said solution as being correct by said administrator;
distributing a prize to the player submitting said verified solution.

2. The method of claim 1 further comprising providing said administrator a computer-controlled device configured with an input-output and communications configuration to execute a program on a non-transitory computer readable medium to each of said enrolled players.

3. The method of claim 1 further comprising requiring said first set of players recruiting and enrolling at least a second set of two players, each completed recruiting and enrolling being followed by transmitting to said first set of players at least one additional clue.

4. The method of claim 1 further comprising requiring players enrolling additional players until a number of players reaches a threshold set by the administrator for releasing clues.

5. The method of claim 1 further comprising a configuration whereby said distributing a prize to the player submitting said verified solution includes an ability to share or distribute the prize with at least one other player.

6. The method of claim 1 whereby said providing a solution includes comprising a time—date stamp with said solution for verification of an initial correct solution.

7. The method of claim 1 whereby said players enrolling includes providing monetary enrollment fees.

8. The method of claim 1 whereby said players enrolling includes providing monetary enrollment fees deposited into an escrow fund controlled by said administrator.

9. The method of claim 1 whereby distributing said prize to the player submitting said verified solution includes withdrawing money from monetary enrollment fees deposited into an escrow fund controlled by said administrator.
